(19) United States
(12) Patent Application Publication
(10) Pub. No.: US 2004/0179923 A1
(43) Pub. Date: Sep. 16, 2004

(54) Automated transportation mechanism for conveyence and positioning of test containers

(75) Inventors: Eric Beach, Endicott, NY (US); Michael E. Caporali, Endicott, NY (US); John J. Ford, Johnson City, NY (US); Glenn L. Kehley, Endicott, NY (US); John T. Swider, Port Crane, NY (US); Christopher J. Tatar, Endicott, NY (US); Louis B. Taylor, Apalachin, NY (US); John M. Wazenski, Athens, PA (US)

Correspondence Address: PERKINS, SMITH & COHEN LLP, ONE BEACON STREET, 30TH FLOOR, BOSTON, MA, 02108, US

(73) Assignee: Lockheed Martin Corporation

(21) Appl. No.: 10/744,128

(22) Filed: Dec. 23, 2003

Related U.S. Application Data
(60) Provisional application No. 60/436,210, filed on Dec. 23, 2002.

(51) Int. Cl. B65G 65/04

(52) U.S. Cl. 414/416.01

(57) ABSTRACT

An apparatus for providing test containers to a test position, includes a track adapted to guide test containers to a test position, a magazine adapted for holding a plurality of test containers and operatively engaged with the track to provide test containers to the track, and a drive mechanism adapted for moving individual test containers from the magazine and along the track to the test position. The magazine for serially providing a plurality of test containers, includes a housing forming a chamber adapted for holding a multiplicity of elongated test containers in parallel and adjacent alignment along a row, a stop element formed at one end of the housing in parallel alignment with the test containers, and a biasing mechanism adapted for physically biasing the row of test containers against the stop element, wherein the one end of the housing including an opening located adjacent to the stop element and adapted to allow test containers to be removed from the chamber.

### CROSS-REFERENCE TO RELATED APPLICATIONS

The present application claims priority from U.S. Provisional Application serial No. 60/436,210, filed Dec. 23, 2002, entitled AUTOMATED TRANSPORTATION MECHANISM FOR CONVEYENCE AND POSITIONING OF TEST CONTAINERS FOR FLUID TRANSFER hereby incorporated by reference herein.

### FIELD OF THE INVENTION

The present application generally relates to testing apparatuses and particularly to such apparatuses which use an automated supply of test containers.

### BACKGROUND OF THE INVENTION

The general threat of terrorist activities, and particularly the potential for terrorist deployment of hazardous substances, has led to significant interest in routine testing of common substances, such as air and water, which may be used as a delivery mechanism for such hazardous substances. Consistent with this increased interest is the desire for automated testing of such common substances for purposes of efficiency and minimization of human effort. One particular application for such routine automated testing is the continuous testing of air in mail processing facilities. The regular collections and delivery of new mail items into such facilities requires continuous testing to ensure that newly arrived items do not introduce contaminants. Thus, it is desirable to have automated testing equipment which enables continuous testing, but which does not require continuous operation by personnel.

### SUMMARY OF THE INVENTION

Accordingly, one embodiment of the present invention covers an apparatus for providing test containers to a test position, comprising a track adapted to guide test containers to a test position, a magazine adapted for holding a plurality of test containers and operatively engaged with the track to provide test containers to the track, and a drive mechanism adapted for moving individual test containers from the magazine and along the track to the test position.

The track may include a slot located along the track. The drive mechanism may be adapted to push a first portion of individual test containers along the track while a second portion of individual test containers extends through the slot. The track may include a substantially horizontal surface on one side of the slot and a substantially vertical surface on another side of the slot.

The track may allow access to the test containers from a side direction thereof and from a top direction thereof. The drive mechanism may comprise a drive belt aligned with the track and a protruding member affixed to the drive belt and adapted to contact an individual test container located within the magazine or on the track and move the individual test container from the magazine and along the track. The apparatus may further comprise a sensor adapted for sensing a position of individual test containers along the track in alignment with the test position. The apparatus may also comprise a disposal container, wherein the track extends beyond the test position to the disposal container and the drive mechanism is further adapted for moving individual test containers from the test position to the disposal container. The magazine may be adapted to serially present individual test containers in alignment with the track.

In another embodiment, the present invention covers a method for providing test containers to a test position, comprising providing a plurality of test containers within a magazine, aligning and engaging the magazine with a track adapted to guide the test containers to a test position, and pushing individual the test containers from the magazine and along the track to the test position.

The step of providing test containers may include serially presenting individual test containers in alignment with the track. The step of pushing test containers may include moving a first portion of the test container along the track while a second portion of the test container extends through a slot located along the track.

The step of pushing test containers may include powering a drive belt in alignment with the track and contacting a test container located within the magazine or along the track with a protruding member affixed to the drive belt. The step of pushing test containers may further include sensing a position of a test container in alignment with the test position and stopping the drive belt in response thereto. The method may further comprise reversing the drive belt to move the protruding member away from the test container when it is in alignment with the test device.

The method may further comprise pushing the test containers away from the test apparatus for disposal.

Yet another embodiment of the present invention covers a magazine for serially providing a plurality of test containers, comprising a housing forming a chamber adapted for holding a multiplicity of elongated test containers in substantially parallel and adjacent alignment along a row, a stop element formed at one end of the housing in substantially parallel alignment with the test containers, and a mechanism adapted for physically biasing the row of test containers against the stop element, wherein the one end of the housing includes an opening located adjacent to the stop element and adapted to allow test containers to be removed from the chamber.

The chamber may includes a first portion adapted to hold a first portion of the test containers in alignment between the stop element and the biasing mechanism, and a second portion located adjacent to the first portion and adapted for locating a second portion of the test containers.

The one end of the housing may include a second opening located adjacent to the stop element and opposed to the first opening and adapted to allow a test container in contact with the stop element to be pushed from the magazine through the first opening.

The first opening may include a first portion corresponding to the first portion of the test containers and a second portion corresponding to the second portion of the test containers.

### BRIEF DESCRIPTION OF THE DRAWINGS

The present invention is illustratively shown and described in reference to the accompanying drawings, in which:

FIG. 1 is a pictorial view of one side of an apparatus constructed in accordance with one embodiment of the present invention;

FIG. 2 is a pictorial view of an opposing side of the apparatus of FIG. 1 showing an input magazine and a disposal bin in exploded view;

FIG. 3 is a pictorial view of a portion of the apparatus of FIG. 1;

FIG. 4 is another version of the pictorial view of FIG. 3;

FIG. 5 is yet another version of the pictorial view of FIG. 3;

FIG. 6 is an exploded view of a disassembled magazine constructed in accordance with another embodiment of the present invention and used in combination with the apparatus of FIG. 1;

FIG. 7 is partially exploded view of the magazine of FIG. 6;

FIG. 8 is a side view of the magazine of FIGS. 6 and 7; and

FIG. 9 is a pictorial view of the bottom of the apparatus of FIG. 1.

### DETAILED DESCRIPTION OF THE DRAWINGS

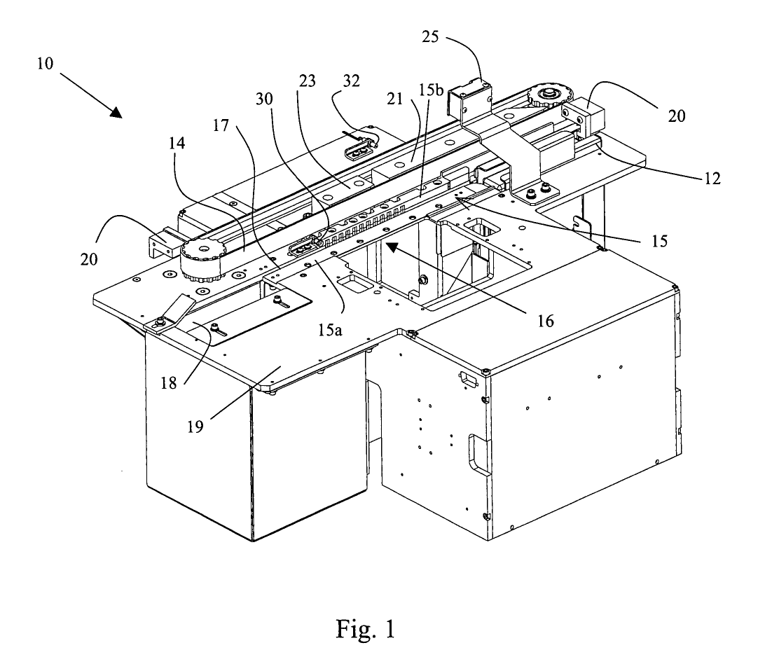

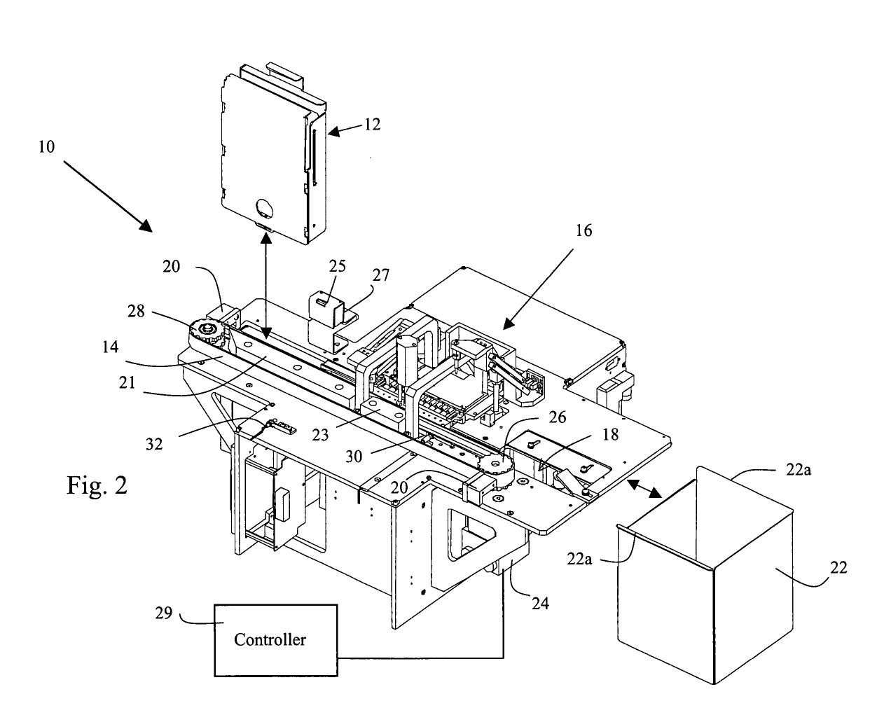

FIGS. 1 and 2 show the same apparatus 10 from opposing pictorial views. Apparatus 10 generally includes an input magazine 12, a drive belt 14, a test position 16 and a disposal port 18. Further shown are a pair of cleat-like protruding members 20, which are attached to drive belt 14 and used to push test containers along a track 15 and slot 17 formed in the top deck 19 of apparatus 10. Magazine 12 is adapted to hold a plurality of test containers and is mounted in alignment with track 15 to provide test containers thereto.

Track 15 is formed by a generally horizontal surface 15a, which is part of top deck 19 and is located on one side of slot 17, and a generally vertical or orthogonal surface 15b, which is located on the other side of slot 17. Although surfaces 15a and 15b are orthogonal in the present apparatus, the precise orientation and relationship between these two surfaces 15a and 15b may vary somewhat depending upon the test container being handled.

In this manner, apparatus 10 allows access to a test container in track 15 from both one side thereof and also from the top side thereof. In the present apparatus, the top access is temporary as protruding member 20 reaches down to access individual test containers from above to move them along track 15. The side access (lower right to upper left in FIG. 1) may be used on a full time basis by test equipment at test position 16. Vertical surface 15b serves as a horizontal support or back stop to test containers at test position 16.

FIG. 2 shows magazine 12 and disposal bin 22 removed from the apparatus 10. Further shown in some detail is drive belt 14 and a drive mechanism including a servo motor 24, a drive pulley 26 and an idler pulley 28. The movement of drive belts 14 by servo motor 24 is controlled as described below by a controller 29, representationally shown, in response to a plurality of photoelectric sensors 30, 32. Photo sensor 30 detects the position of test containers at test position 16, while photo sensor 32 detects a homing position for protruding members 20. Belt 14 is properly tensioned by known methods and the lateral position of drive belt 14 with respect to track 15 is ensured by two guides 21 and 23. Drive belt 14 and pulleys 26, 28 are constructed with complementary drive teeth (not shown) to ensure and maintain proper engagement and to provide sufficient drive force to protruding members 20.

Also shown is a bar code reader/scanner 25 and a nominal test apparatus at test position 16 (FIG. 2). Reader/scanner 25 can take advantage of temporary overhead access to test containers by reading information displayed on the test container such as a serial number bar code, which number can be recorded on a computer along with the date and time. Reader/scanner 25 is attached to a bracket 27 that positions reader/scanner 25 slightly in front of and above magazine 12. In this position, a test container is exposed below reader/scanner 25 as it is being pushed from magazine 12 and the serial number is read

In operation, a supply of test containers (not shown) are serially provided by magazine 12. Servo motor 24 drives belt 14 and protruding members 20 to push individual test containers from magazine 12, along track 15 to test position 16, and after testing, to disposal port 18 and bin 22. In this manner, the present apparatus allows a test apparatus to operate continuously, without operator intervention, at least for the duration of the supply of test containers in magazine 12.

Disposal bin 22 is a box-like container made of metal, plastic or the like and set at a vertical height below top deck 19 on the exit side of transport apparatus 10. Disposal bin 22 may be fitted with a sealable waste treatment baggie for collection of all used test containers. Brackets attached to the underside of top deck 19 accept flanges 22a on disposal bin 22, such that disposal bin 22 can be slid into position and easily removed for disposal of used test containers. A magnet (not shown) mounted on the underside of top deck 19 can be used to secure a metal disposal bin 22 in position.

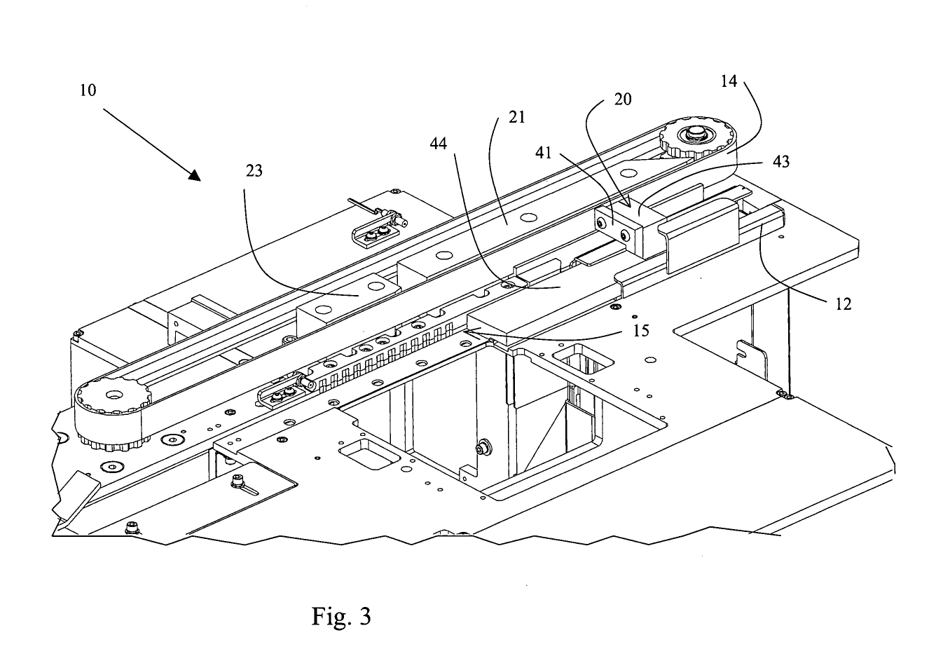

The pictorial view of FIG. 3 is a close up view of the apparatus 10 of FIGS. 1 and 2 showing a test container 44, which is being pushed from magazine 12 along track 15 by cleat-like protruding member 20. Protruding members 20 are designed with a front member 41, which is attached to belt 14, and a back support 43, which is only attached to front member 41. Back support 43 impacts belt 14 while cleat 20 is pushing a test container and maintains the position of front member 41 at a substantially right angle to belt 14. Belt 14 is prevented from laterally distorting under the load of pushing test container 44 by the presence of support guides 21, 23.

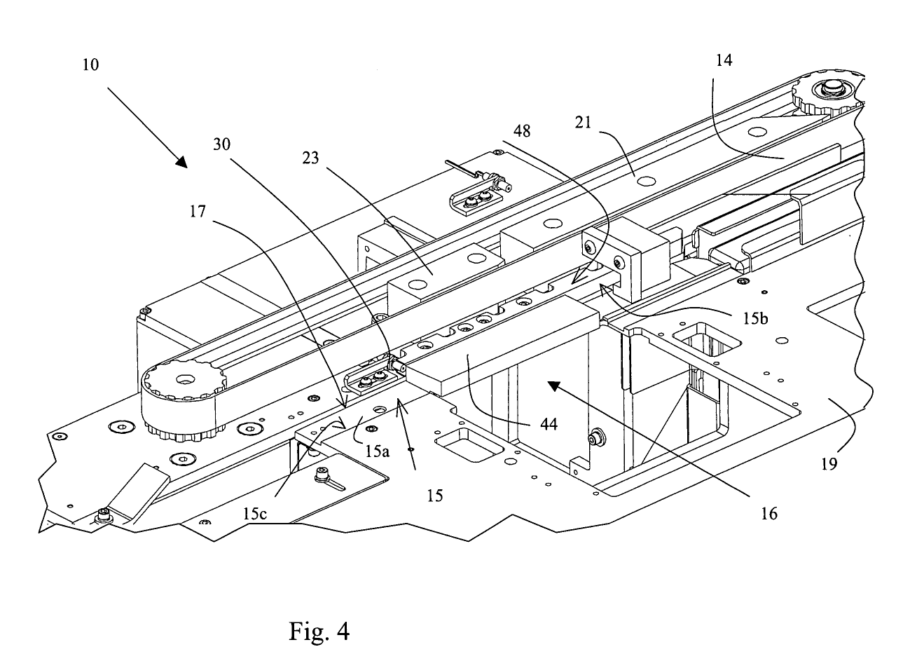

FIG. 4 is another close up pictorial view of the apparatus 10 showing a test container 44 located in alignment with test position 16 along track 15. Track 15 is formed around slot 17 by substantially horizontal surface 15a, which is generally formed on the surface of top deck 19 and a pusher bar 48 having a substantially vertical surface 15b that is substantially orthogonal to surface 15a. This arrangement of track 15 with central slot 17 formed between surfaces 15a and 15b, maintains the orientation of test containers 44 within track 15 over the course of their movement. A lip 15c, generally facing surface 15b, may also be used to retain test containers in track 15. As mentioned, the relationship between surfaces 15a and 15b depends upon the form of test container, and the present apparatus would also function with test containers 44 if surfaces 15a and 15b were orthogonal but canted from their present respective horizontal and vertical orientations.

The proper positioning of test container 44 at test position 16 is accomplished by means of photo sensor 30, which is located to directly sense the proper location of test container 44. Controller 29 (FIG. 2) is designed to stop movement in response to sensor 30 and then reverse motor 24 to back protruding member 20 away from test container 44 during testing.

As mentioned, belt 14 is maintained in parallel with track 15 and slot 17 by a pair of guides 21, 23, which prevent belt 14 from distorting while pushing test containers. Guides 21, 23 may be made of UHMW plastic material with a profile similar to projecting teeth on belt 14 to rigidly secure, direct, stabilize and captivate the belt 14 in this parallel orientation. The low frictional coefficient of this material allows the belt 14 to slide freely along guides 21, 23.

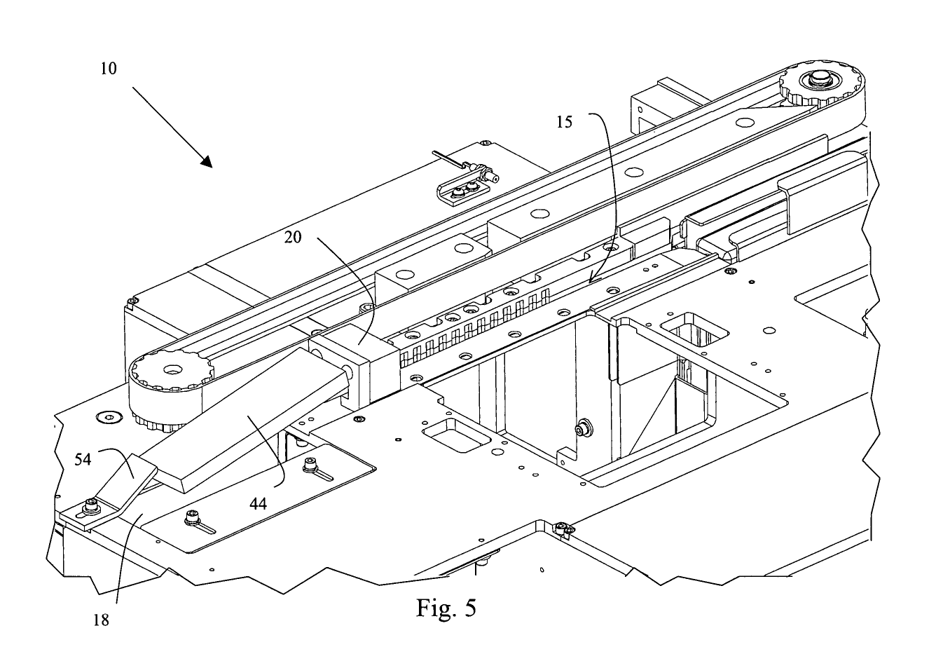

FIG. 5 is another pictorial view of apparatus 10 showing a test container 44, which has been moved by a protruding member 20 in the direction of disposal port 18. Disposal port 18 is shown with a deflector or derailleur 54, which is adapted to ensure that test containers 44 move from track 15 through disposal port 18.

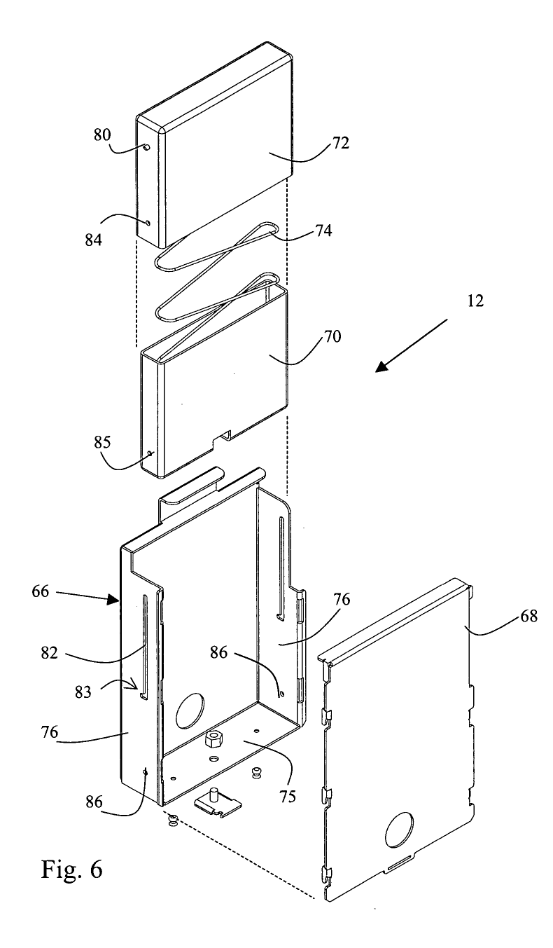

FIG. 6 is an exploded view of the parts of a magazine 12. Generally included is a chassis 66, a cover 68, an elevator guide 70, an elevator platform 72 and a spring 74. Elevator guide 70 and elevator platform 72 are adapted to be located at the lower end 75 of chassis 66. Elevator guide 70 is adapted to be affixed to lower end 75, and elevator platform 72 is adapted to be located in concentric engagement with elevator guide 70. Spring 74 is bolted at one end thereof to lower end 75 and enclosed inside of elevator guide 70 and elevator platform 72.

Elevator platform 72 includes a pair of pins 80 extending from opposite ends of platform 72, which pins 80 are adapted to engage platform guide slots 82 located in the sides 76 of chassis 66. The length of guide slot 82 shows the range of movement of elevator platform 72 as the number of test containers located within magazine 12 changes. Guide slots 82 each includes a lip 83 at the lower end to retain elevator platform 72 in its lowest position during the loading of test containers. Magazine 12 also includes a further retention means for elevator platform 72 in the form of retention holes 84 located in opposing ends of platform 72, retention holes 85 located in opposing ends of elevator guide 70 and retention holes 86 located in opposing sides 76 of chassis 66. By these means, elevator platform 72 can be pressed against spring 74 to the lowest position of platform 72 and a separate pin (not shown) can be inserted through respective holes 84, 85 and 86 to retain elevator platform 72 in its lowest position while test containers are loaded into magazine 12.

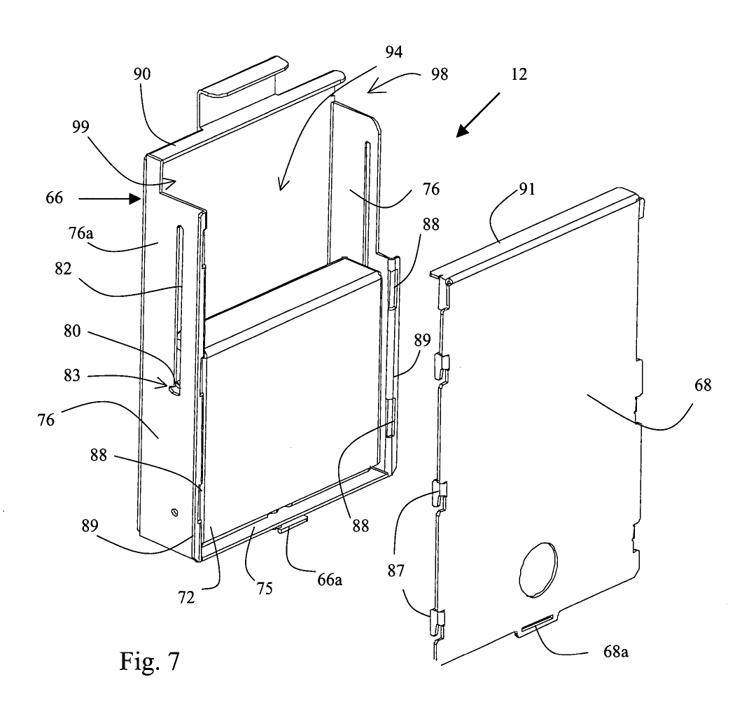

FIG. 7 is another pictorial view of magazine 12 in a partially assembled condition ready to receive test containers. Elevator guide 70 (FIG. 6) is affixed to the bottom 75 of chassis 66. Elevator platform 72 encloses elevator guide 70 and spring 74 (FIG. 6) and is compressing spring 74 to the lowest position of elevator platform 72. Pins 80 are engaged with a lip 83 to retain elevator platform in this lowest position. This arrangement of chassis 66 and elevator platform 72 is used for loading test containers into magazine 12, after which cover 68 is attached to close chassis 66.

Cover 68 is adapted to attach to chassis 66 with a multiplicity of tabs 87 adapted to engage holes or slots 88 located in flanges 89 on the sides 76 of chassis 66. Tabs 87 are inserted through respective slots 88 and cover 68 is moved downwardly until slot 68a on cover 68 engages a lip 66a attached to chassis 66. Chassis 66 and cover 68 further include a pair of stop flanges 90, 91, respectively. Flanges 90, 91 form a stop against which test containers are pressed by elevator platform 72 and spring 74 (FIG. 6).

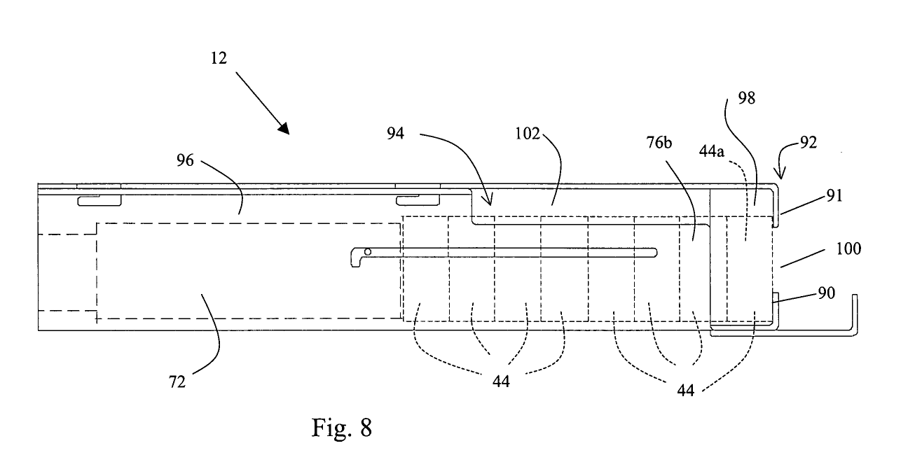

FIG. 8 is a side view of a closed magazine 12, in which the bias mechanism of elevator platform 72 and spring 74 is pressing a multiplicity of test containers 44 against flanges 90, 91. Flanges 90, 91 form a stop element 92 on one end of magazine 12, against which stop element 92 test containers 44 are biased. Test containers are shown to be located within a chamber 94 (see also FIG. 7) of chassis 66, which further includes a second chamber 96 adapted to loosely hold a second portion of test containers 44. Magazine 12 is also shown to have an opening 98 through which an end of the first test container 44a is exposed. In operation, individual test containers are pushed through opening 98 with a protruding member 20 (FIG. 3), which also passes through opening 98 and through the space 100 located between stop flanges 90, 91. The opposing side 76a (FIG. 7) of chassis 66 includes a similar opening 99 (FIG. 7), which allows protruding members 20 to enter magazine 12 The side 76b of magazine 12 also includes an extended portion 102 of opening 98, which extended portion 102 allows a second portion of test containers 44 to exit magazine 12.

The components of magazine 12 can be made of plastic or sheet metal. Any other cost effective materials suitable to this function are also acceptable. Magazine 12 can be an inexpensive “throw away” item or can be refillable and reusable.

As each test container clears magazine 12, the next test container in the row is advanced into position next to stop element 92, by spring 74 pushing substantially evenly on the elevator platform 72, to await the next protruding member 20 (FIG. 3). Elevator platform 72 can advance from a fully retracted position as shown in FIG. 8 to the fully extended position substantially perpendicular to the inside walls of chassis 66. the biasing force determined by the spring constant of spring 74The spring operation is sufficient to create a sufficient spring load on the elevator platform 72 such that the elevator platform 72 advances all test containers to opening 98. When magazine 12 is empty, elevator platform 72 is restricted from blocking openings 98 and 99 so that protruding members 20 (FIG. 3) pass easily there between and through magazine 12.

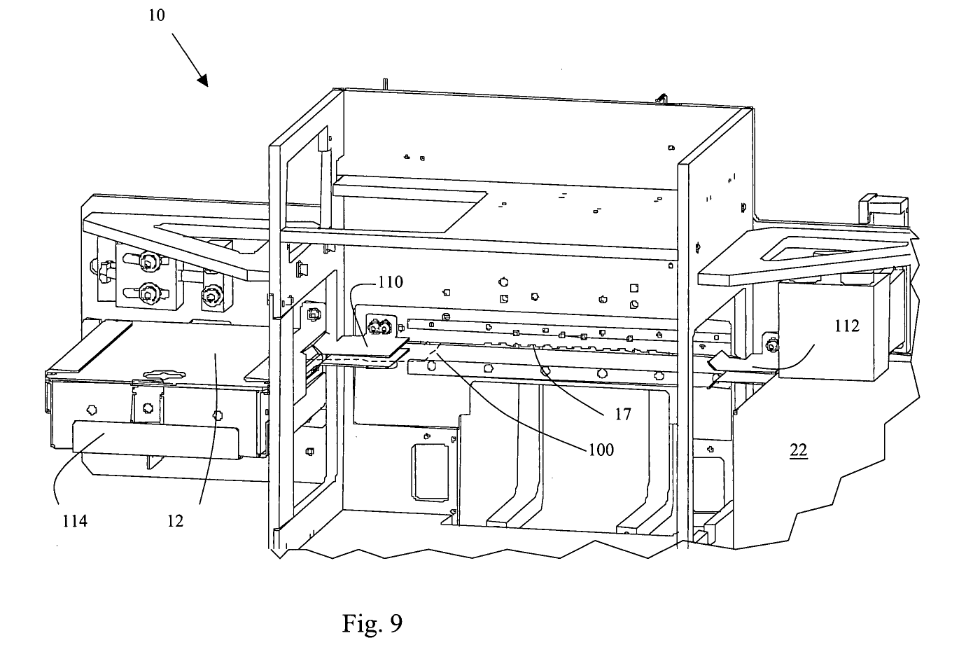

FIG. 9 is an partial pictorial view of apparatus 10 taken from underneath. FIG. 9 shows two pairs of guides 110, 112 located for guiding portions 100 (shown in phantom) of the test containers, both from magazine 12 and into disposal bin 22, respectively. Portions 100 are attached to test containers 44 (FIGS. 3-5) and extend through slot 17.

FIG. 9 also shows a bracket 114 for mounting magazine 12, which bracket 114 is attached to the underside of top deck 19. Bracket 114 is configured along with cut-outs (not shown) in top deck 19 such that projecting tabs (not shown) on two opposing sides of magazine 12 allow it to be inserted in only one orientation. A micro switch (not shown) located on bracket 114 reports the presence of magazine 12 to controller 29, hence allowing the test cycle to begin.

Controller 29 is used to control all actions and activities associated with transportation of test containers in response to the monitored activities of motor 24, sensors 30, 32 and the micro switch. Those activities and instructions are associated with but not limited to motion start and stop, counting, homing, positioning, magazine presence and back-away or withdrawal. A typical operational scenario is as follows:

a. System is powered on;

b. System starts, by cycling to identify a home position when sensor 32 detects the presence of a protruding member 20 and then stops;

c. System alerts an operator to load magazine 12;

d. Magazine presence is detected by the microswitch;

e. System starts and the first test container is extracted from magazine and is moved to testing position 16 as determined by sensor 30;

f. Protruding member is withdrawn;

g. System signals test apparatus to initiate a chemical test procedure;

h. Test apparatus completes the test procedure and signals for the next test container.

i. System uses a protruding member to push the used test container into disposal bin 22;

j. Second test container is extracted from magazine 12 and pushed to test position 16;

k. Process steps f-j are repeated until a last test container from magazine 12 is pushed into disposal bin 22; and

l. System stops to await a new magazine when the next protruding member 20 passes through the empty magazine 12 and homing sensor 32 detects a protruding member 20 before sensor 30 detects anything.

Although this System has been described with respect to various embodiments, it should be recognized that this invention is also capable of a wide variety of other methods, applications and adaptations, within the spirit and scope of the above disclosure. For example, top deck 19 may be constructed from a single piece of material, such as aluminum, into which slot 17 is cut, or it may be made from a pair of aluminum deck plates separated by a small gap which forms slot 17. This gap is closed on the ends by lap joints and fasteners securing the two deck plates.

The present invention is illustratively described above in reference to the disclosed embodiments. Various modifications and changes may be made to the disclosed embodiments by persons skilled in the art without departing from the scope of the present invention as defined in the appended claims.

What is claimed is:

1. An apparatus for providing test containers to a test position, comprising:
a track adapted to guide test containers to a test position;
a magazine adapted for holding a plurality of test containers and operatively engaged with said track to provide test containers to said track; and
a drive mechanism adapted for moving individual test containers from said magazine and along said track to said test position.

2. The apparatus of claim 1, wherein said track includes a slot located along said track.

3. The apparatus of claim 2, wherein said drive mechanism is adapted to push a first portion of individual test containers along said track while a second portion of individual test containers extends through said slot.

4. The apparatus of claim 2, wherein said track includes a substantially horizontal surface on one side of said slot and a substantially vertical surface on another side of said slot.

5. The apparatus of claim 1, wherein said track allows access to the test containers from a side direction thereof and from a top direction thereof.

6. The apparatus of claim 1, wherein said drive mechanism comprises a drive belt substantially aligned with said track and a protruding member affixed to said drive belt and adapted to contact individual test containers located within said magazine or on said track and move the individual test containers from said magazine and along said track.

7. The apparatus of claim 1, further comprising a sensor adapted for sensing a position of individual test containers along said track in alignment with said test position.

8. The apparatus of claim 1, further comprising a disposal container, wherein said track extends beyond said test position to said disposal container and said drive mechanism is further adapted for moving individual test containers from said test position to said disposal container.

9. The apparatus of claim 1, wherein said magazine is adapted to serially present individual test containers in alignment with said track.

10. A method for providing test containers to a test position, comprising the steps of:
providing a plurality of test containers within a magazine;
operatively engaging said magazine with a track adapted to guide the test containers to a test position; and
pushing individual test containers from the magazine and along the track to the test position.

11. The method of claim 10, wherein said step of providing includes serially presenting individual test containers in alignment with the track.

12. The method of claim 10, wherein said step of pushing includes moving a first portion of each test container along the track while a second portion of the test container extends through a slot located along the track.

13. The method of claim 10, wherein said step of pushing includes powering a drive belt in alignment with the track and contacting a test container located within the magazine or along the track with a protruding member affixed to the drive belt.

14. The method of claim 13, wherein said step of pushing includes sensing a position of a test container in alignment with the test position and stopping the drive belt in response thereto.

15. The method of claim 14, further comprising the step of reversing the drive belt to move the protruding member away from a test container when the test container is in alignment with the test position.

16. The method of claim 10, further comprising the step of pushing individual test containers away from the test apparatus for disposal.

17. A magazine for serially providing a plurality of test containers, comprising:
a housing forming a chamber adapted for holding a multiplicity of elongated test containers, in substantially parallel and adjacent alignment along a row;
a stop element formed at one end of said housing in substantially parallel alignment with the test containers;
a mechanism adapted for physically biasing the row of test containers against said stop element; and
said one end of said housing including an opening located adjacent to said stop element and adapted to allow individual test containers to be removed from said chamber.

18. The magazine of claim 17, wherein said chamber includes a first chamber portion adapted to hold a first portion of the test containers in alignment between said stop element and said biasing mechanism, and a second chamber portion located adjacent to said first chamber portion and adapted for locating a second portion of the test containers.

19. The magazine of claim 18, wherein said one end of said housing further includes a second opening located adjacent to said stop element and opposed to the first said opening and adapted to allow a test container in contact with said stop element to be pushed from said magazine through the first said opening.

20. The magazine of claim 18, wherein the first said opening includes a first portion corresponding to the first portion of the test containers and a second portion corresponding to the second portion of the test containers.
